(19) United States
(12) Patent Application Publication
(10) Pub. No.: US 2026/0068825 A1
(43) Pub. Date: Mar. 12, 2026

(54) PLANTER WITH A REMOVABLE FLOOR

(71) Applicant: Lucy A. MITCHELL, Wiltshire (GB)

(72) Inventor: Lucy A. MITCHELL, Wiltshire (GB)

(21) Appl. No.: 19/394,346

(22) Filed: Nov. 19, 2025

Related U.S. Application Data
(63) Continuation of application No. 17/443,902, filed on Jul. 28, 2021.
(60) Provisional application No. 63/061,250, filed on Aug. 5, 2020.

(51) Int. Cl. A01G 9/02

(52) U.S. Cl. CPC A01G 9/028; A01G 9/0302

(57) ABSTRACT

A planter includes a container and a removable floor designed for easy and non-damaging plant removal. The container features a multi-stage retention system on its inner sidewall. An internal floor flange provides a base for an upwardly extending lip that defines a support surface. Vertically above this lip, a primary retention groove is formed. Vertically above the groove, a plurality of inwardly protruding structures provide a secondary retention point. A removable floor is inserted by being pressed past the protruding structures to snappingly engage the primary retention groove, while being vertically supported by resting on the lip. This “rest-on, snap-above” configuration, combined with the multi-stage retention, secures the floor during use but allows the floor and an entire soil mass to be easily pushed upward from below for safe repotting. The removable floor may include distinct inner and outer apertures for separate central and peripheral drainage paths.

### CROSS-REFERENCE TO RELATED APPLICATION

This application is a continuation of and claims priority under 35 U.S.C. § 120 to U.S. patent application Ser. No. 17/443,902, filed Jul. 28, 2021, which application claims priority to U.S. Provisional Patent Application No. 63/061,250 , filed Aug. 5, 2020, which applications are incorporated herein by reference in their entireties.

### FIELD The present invention relates to a planter having a removable floor.

### BACKGROUND

Single pot planters and seedling planters are common tools used to grow indoor and outdoor plants. Traditionally, a planting pot has a single container that holds a single plant, whereas a seedling tray planter has a single container with various compartments that holds multiple individual seedlings within the compartments. Both types of planters normally do not have a removable floor used to push plants out of the container to allow for safe transfer of plants during repotting. Seedling planters also normally do not have removable dividers to separate individual seedlings within a seedling tray.

Repotting plants is essential to keep plants vibrant and growing. Young plants are often repotted for the purpose of transferring the plant to a permanent planting bed or pot. Other plants must be repotted at least once or twice per year to keep the plant healthy. A problem with traditional planters is that they do not allow for the easy and safe transfer of plants. Typically, both a single pot planter and a seedling planter must be turned upside down to loosen the plant away from the sides of the pot. Soil is usually lost during this inversion which can have a negative effect on plant viability. The loose soil is very difficult to keep in place when attempting to re-pot a plant or re-plant a plant into a flower bed. To loosen the plant away from a plastic planter, the portion of the pot the plant is secured into is squeezed from the sides and the bottom, and the plant is pulled out from the top to lift it away from the pot. This process causes damage to the plant and the roots. To remove plants from non-flexible planters, an additional tool, such as a hand shovel is needed to remove the plant from the pot. The use of the hand tool can result in damage to the roots. The removal of larger plants or shrubs is especially difficult under these conditions, and typically involves cutting the plant out of the temporary plastic container because of its weight. This process not only has the ability to damage the roots of the plant, but it can also harm the user removing the plant. Additionally, removing any plant or shrub from traditional planters is difficult and takes up a large amount of time. Plants in distress often die shortly after repotting which wastes more time and money.

A problem with traditional planters is that they do not allow quick and safe transfer of plants during repotting, and the process used to remove the plants from these planters often has a negative effect on the roots of the plants.

Thus, there is a long-felt need to be able to easily repot a single plant or several plants without damaging or killing the plant being transferred or the adjacent plants within a seedling tray planter.

Further, there is a long-felt need for a planter in the form of a single pot or seedling tray, that has a removable floor that provides an easy way of removing the floor to adjust soil or the seedlings planted therein.

Still further, there is a long-felt need for a planter in the form of a single pot or seedling tray, that has a removable floor that allows excess liquid to drain from the plant container.

Even further, there is also a long-felt need for a planter in the form of a tray that has removable seedling dividers to accommodate easy cleaning along with soil and seedling adjustment, or individual seedling removal.

### SUMMARY

The present disclosure, in a broad aspect, provides a planter which includes a container and a removable floor designed for easy and non-damaging plant removal. The container features a multi-stage retention system on its inner sidewall. An internal floor flange provides a base for an upwardly extending lip that defines a support surface. Vertically above this lip, a primary retention groove is formed. Vertically above the groove, a plurality of inwardly protruding structures each provide a secondary retention point. A removable floor is inserted by being pressed past the protruding structures to snappingly engage the primary retention groove, while being vertically supported by resting on the lip. This “rest-on, snap-above” configuration, combined with the multi-stage retention, secures the floor during use but allows the floor and an entire soil mass to be easily pushed upward from below, through a large central aperture, for safe repotting. The removable floor may include distinct inner and outer apertures for separate central and peripheral drainage paths.

In some aspects, the disclosure provides a planter having a continuous sidewall with an inner surface and an outer surface forming a container with a top and a bottom end, an internal floor flange extending inwardly from the inner surface of the sidewall proximate a bottom end of the container, and a lip extending upwardly from the flange, the lip defining a drainage aperture at the bottom end of the container, a drainage channel formed by the internal floor flange, the lip, and the sidewall, a plurality of apertures in the sidewall in communication with the drainage channel; and, a removable floor arranged to rest on the lip having a plurality of inner floor apertures arranged to drain liquid via the drainage aperture, and a plurality of outer floor apertures arranged to drain liquid via the drainage channel and the plurality of apertures in the sidewall.

The present disclosure additionally provides a planter, comprising a plurality of integral sidewalls connected to one another to form a container, each sidewall having a top and a bottom end, an internal floor flange extending inwardly from the sidewalls, proximate the bottom end of the sidewall, a removable floor arranged to rest on the internal floor flange; and, a plurality of removable partitions operatively arranged to fit within the container and rest atop the removable floor.

The primary object of the described planters is a removable floor to allow for the easy transfer of plants during repotting and flower bed planting, without damaging the plant by forcefully pulling on the top of the plant and ripping the root formation to release the plant out of the pot. The removable floor is placed within the container of the planter and snappingly engages the groove of the sidewall near the bottom end of the container. The plant grows within the planter, and the removable floor that rests under the soil of the plant remains loose throughout the growing and root formation processes for easy plant removal later. To remove the plant from the pot, the removable floor is pushed on with a hand, a tip of a shoe, a planting tool, the bottom of a smaller pot, etc., through the bottom drainage channel of the container in an upward direction toward the top end opening of the container. As the plant is pushed out of the pot, it remains intact with the soil. The removable floor can be peeled from the bottom of the plant to preserve root formation and maintain plant viability.

Pushing the plant out of the container has many advantages over the traditional way of removing a plant out of a container by pulling upwardly on it. Pushing the plant out does not require turning the planter upside down, and thus prevents the necessary soil from falling out. Pushing the plant out from the bottom end of the container also allows for the conservation of the soil and root formation and stops root ripping. Alternatively, pushing the plant out from the bottom end of the container also saves the time it takes to repot the plant.

A further object of the disclosure is to provide a planter that provides a way to remove just one or several plants with minimal disturbance to other plants, without inverting the planter upside down.

Another object of the disclosure is to provide a planter that provides a way for automated machines, robots, etc., performing future planting work, to remove plants from pots most efficiently and carefully. Automated machines, robots, etc., can be programmed to remove plants by pushing on the removable floor, instead of by pulling on the top of the plant, and ultimately pulling the plant apart.

Still a further object of the disclosure is to provide a planter that provides the ability to allow excess liquid to drain from the sides and bottom of the planter to prevent the overwatering of plants and to allow breathable airspace for the roots. The planter container provides a drainage aperture proximate the bottom end of the container, a drainage channel formed by an internal floor flange, a lip, and a sidewall of the container, proximate the bottom end of the container, and a plurality of apertures on the sidewall of the container to allow excess liquid to drain out of the planter. When the removable floor is placed inside of the container, liquid can drain into the drainage aperture at the bottom end of the container by flowing through inner floor apertures of the removable floor. Alternatively, or in combination with, liquid can drain into the drainage channel by flowing through outer floor apertures of the removable floor, through the channel, and out through the plurality of apertures on the sidewall of the planter. Alternatively, or in combination with, liquid can also drain through a gap between the removable floor and the top of the plurality of apertures on the sidewall of the planter.

Still another object of the disclosure is to provide a planter having removable partitions to greatly accommodate easier removal of individual plants that can be disassembled and reassembled several times, allowing individual seedling plants to continually grow without harming them.

Yet another object of the disclosure is to provide an easy way of removing the floor and the partition to allow for adjustment of planted seedlings or soil contained within the partition and to allow for an easier way of removing seedlings for re-planting.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a top perspective view of the first embodiment of the present invention;

FIG. 2 is a bottom perspective view of the invention shown in FIG. 1;

FIG. 3 is an exploded view of the invention shown in FIG. 1;

FIG. 4 is an exploded partial cross-sectional view of the invention shown in FIG. 3;

FIG. 5 is a front elevation view of the invention shown in FIG. 1, illustrating only the planter container;

FIG. 6 is an enlarged fragmentary view of the invention shown in FIG. 5, illustrating the bottom end of the container;

FIG. 7 is a top plan view of the invention shown in FIG. 1, illustrating the planter container and the removable floor separately;

FIG. 8 is a top plan view of the invention shown in FIG. 1, illustrating the removable floor inside of the planter container;

FIG. 9 is an enlarged fragmentary view of the invention shown in FIG. 7, illustrating the internal floor flange and the drainage channel proximate the bottom end of the container;

FIG. 10 is a front cross-sectional view of the invention, taken generally along line 10-10 in FIG. 5;

FIG. 11 is a front cross-sectional view of the invention shown in FIG. 10, except illustrating four identical planters as shown in FIG. 10 stacked within one another;

FIG. 12 is an enlarged view of the section of the invention shown in dotted lines in FIG. 11, illustrating the removable floor snappingly engaged with the grove of the sidewall of the container;

FIG. 13 is a top perspective view of a second embodiment of the present invention;

FIG. 14 is an exploded view of the invention shown in FIG. 13; and,

FIG. 15 is a cross-sectional view of the invention, taken generally along line 15-15 in FIG. 13, except illustrating an empty container.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

It should also be appreciated that like reference numbers on different drawing figures represent identical structural elements. It should also be appreciated that, while a number of different embodiments and variations of the present invention are shown in the various drawings, the invention as claimed is not intended to be limited to these specific embodiments, as the claims define a broader invention that can take many different shapes and structures. Also, the adjectives, “top”, “bottom”, “right”, “left”, and their derivatives, in the description herebelow, refer to the perspective of one facing the invention as shown in the figure under discussion.

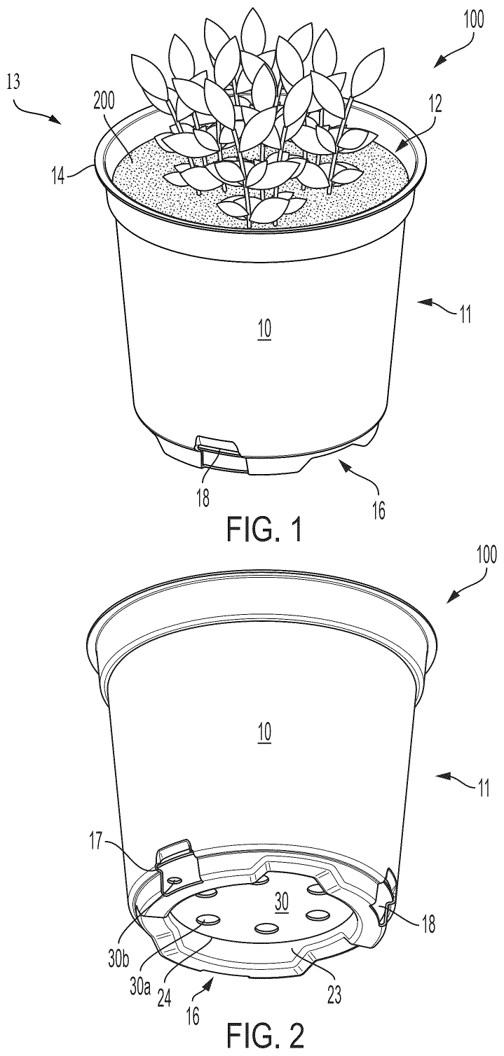

Adverting now to the figures, FIG. 1 illustrates a planter having a removable floor. Planter 100 comprises continuous sidewall 10 forming container 11 that has top end 12 with top opening 13 and an outside edge 14, and bottom end 16. Sidewall 10 of planter 100 includes plurality of apertures 18 spaced equidistantly around bottom end 16 of container 11. This figure displays plant and soil 200 within planter 100 to house a growing plant.

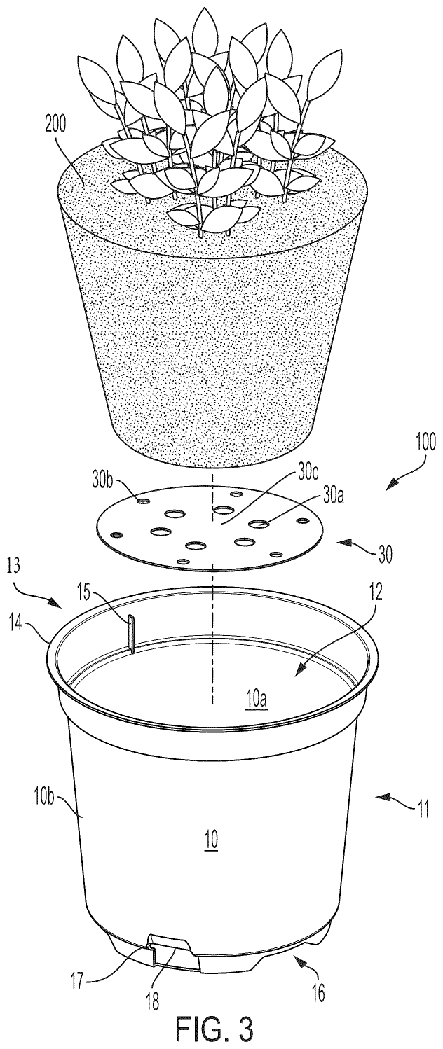

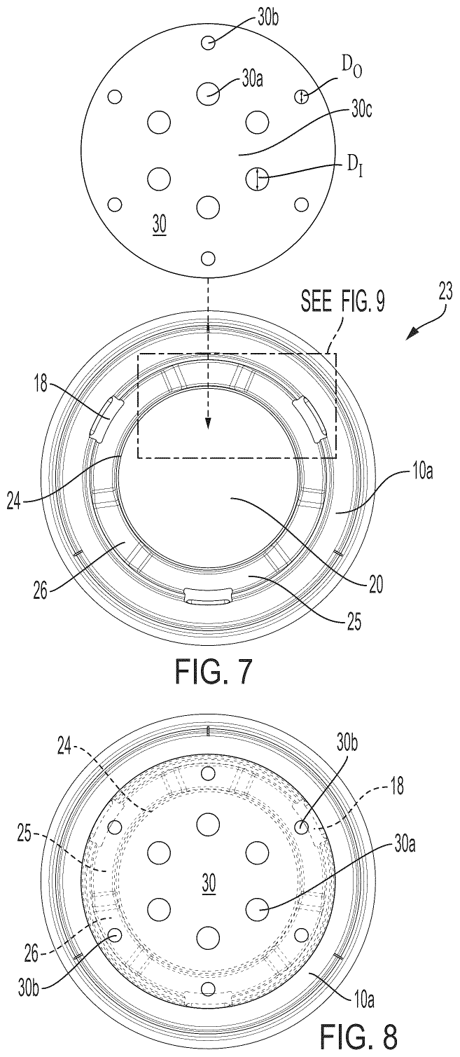

FIG. 2 illustrates internal floor flange 23 having an annular shape in a preferred embodiment, proximate bottom end 16 of container 11 of planter 100 extending inwardly from inner surface 10a of sidewall 10 (shown in FIG. 3), and lip 24 having a cylindrical shape in a preferred embodiment, that extends upwardly from internal floor flange 23. Sidewall 10 comprises groove 17 in inner surface 10a proximate bottom end 16 of container 11. Groove 17 is arranged around the circumference of container 11 proximate bottom end 16. Removable floor 30 rests on lip 24 and snappingly engages groove 17 of inside surface 10a of sidewall 10 to hold and lock the floor in place within container 11. Removable floor 30 comprises plurality of inner floor apertures 30a and plurality of outer floor apertures 30b arranged to allow liquid to drain out of drainage aperture 20 and/or plurality of apertures 18 on sidewall 10 and bottom end 16 of container 11 described in further detail infra. In a preferred embodiment, plurality of inner floor apertures 30a and plurality of outer floor apertures 30b have a circular shape, although they could have other shapes. Further, plurality of inner floor apertures 30a preferably have a diameter, D_{I}, that is greater than the diameter, D_{O}, of outer floor apertures 30b (shown in FIG. 7).

FIG. 3 illustrates an exploded view of the invention shown in FIG. 1, where sidewall 10 of planter 100 comprises inside surface 10a and outside surface 10b to form container 11. Inside surface 10a includes plurality of vertical protrusions 15 proximate outside edge 14 of top end 12 of top opening 13 of container 11. Plurality of vertical protrusions 15 are spaced equidistantly around inner surface 10a of sidewall 10 proximate top end 12 of container 11. Plurality of vertical protrusions 15 aid in stacking planter 100 within other planters described in further detail infra.

Removable floor 30 is shown to include plurality of inner floor apertures 30a, plurality of outer floor apertures 30b, and center 30c. The floor sits within the inside surface 10a of sidewall 10 of container 11 and rests on lip 24 by snappingly engaging groove 17. Plant and soil 200 can be planted within container 11 of planter 100 when removable floor 30 is placed inside container 11. The soil rests atop floor 30 when the planter is in use.

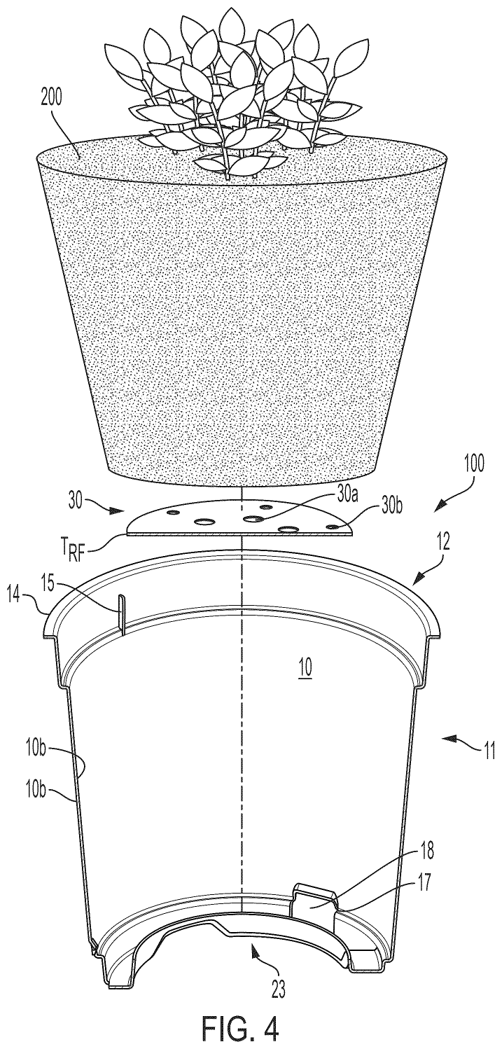

FIG. 4 illustrates an exploded partial cross-sectional view of the invention shown in FIG. 1. It is seen that internal floor flange 23 extends inwardly from inner surface 10a of sidewall 10 proximate bottom end 16 of container 11. Removable floor 30 has thickness T_{RF} described in further detail infra.

As shown in FIGS. 1, 3 and 4, in a preferred embodiment, sidewall 10 defines container 11 which is frustoconical in shape, having a larger diameter at top opening 13 of top end 12 than the diameter at bottom end 16 of container 11. Further, in a preferred embodiment, the diameter at top opening 13 of top end 12 has a larger diameter than that of drainage aperture 20 (shown in FIG. 7) proximate bottom end 16 of container 11 to allow plant and soil 200 to be pushed out of planter 100, described in further detail infra.

To remove plant and soil 200 from planter 100, removable floor 30 is pushed upwardly toward the top opening 13 of top end 12 of container 11. The plant may be lifted, slid, or pushed out by a hand, a tip of a shoe, a small tool, the bottom of an inverted smaller pot, etc., for transplanting. When plant and soil 200 is removed from planter 100, removable floor 30 may be peeled from the bottom of plant and soil 200. Planter 100 may be assembled and disassembled many times to accommodate different individual plants.

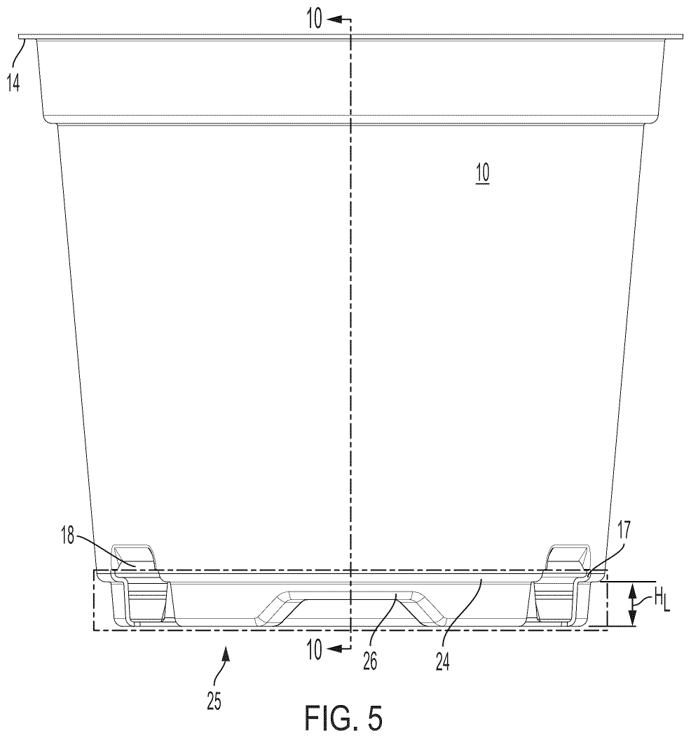

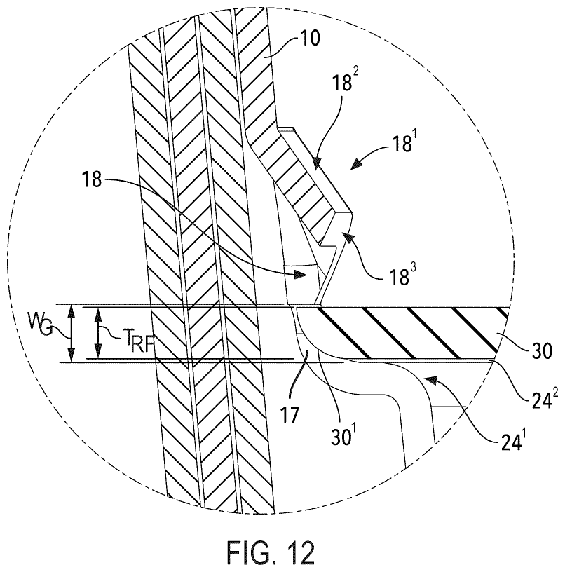

FIGS. 5, 6, and 10 illustrate a front view of container 11 without removable floor 30. Proximate bottom end 16 of container 11 is drainage channel 25 having an annular shape in a preferred embodiment. Drainage channel 25 (best shown in FIG. 7) facilitates draining of excess liquid provided to plant and soil 200. Drainage channel 25 is formed by internal floor flange 23, lip 24, and sidewall 10. In a preferred embodiment, drainage channel 25 further comprises plurality of arcuate trapezoidal protrusions 26 spaced equidistantly around drainage channel 25. Plurality of arcuate trapezoidal protrusions 26 are arranged within drainage channel 25 adjacent plurality of apertures 18 of sidewall 10. Plurality of arcuate trapezoidal protrusions 26 have top surface 26a with height H_{T} that is less than height H_{L} of top edge of lip 24a. Top edge of lip 24a sits below groove 17 of sidewall 10 proximate bottom end 16 of container 11 which allows removable floor 30 to rest on lip 24 and snappingly engages groove 17 of sidewall 10 (shown in FIG. 12).

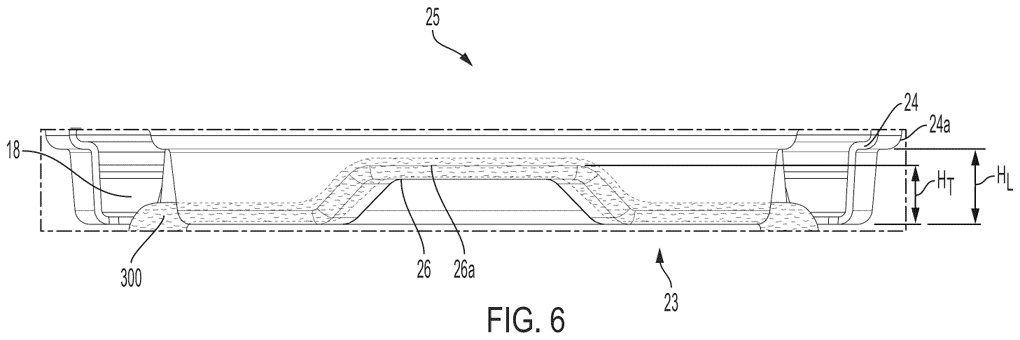

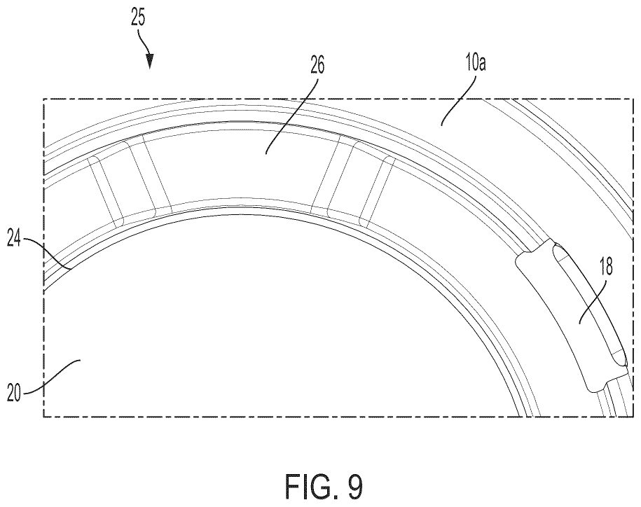

FIG. 6-9 illustrates lip 24 that extends upwardly from internal floor flange 23 and defines drainage aperture 20 proximate bottom end 16 of container 11. In a preferred embodiment, drainage aperture 20 is annular in shape. The figures also illustrate liquid 300 (ideally water) passing through drainage channel 25 and flowing out of plurality of apertures 18 of sidewall 10. Liquid 300 can take the form of a multitude of liquid nutrients, such as, but not limited to, pure water, liquid fertilizer, mineral water, distilled water, rainwater, etc., depending on the plant's classification and the needs of the plant. Excess liquid can drown the plants, and to prevent this, drainage channel 25 moves liquid 300 out of planter 100 through drainage aperture 20 or through plurality of apertures 18 of sidewall 10.

In a preferred embodiment, liquid 300 can drain out of container 11 through drainage aperture 20 proximate bottom end 16 of container 11, or through drainage channel 25 formed by internal floor flange 23, lip 24, and sidewall 10, proximate bottom end 16 of container 11, or through plurality of apertures 18 of sidewall 10. When removable floor 30 is placed within container 11 to rest on lip 24 and snappingly engages groove 17 of sidewall 10 (shown in FIG. 12), plurality of inner floor apertures 30a line up with drainage aperture 20 and plurality of outer floor apertures 30b line up with plurality of apertures 18 on sidewall 10 and drainage channel 25, including plurality of arcuate trapezoidal protrusions 26. This configuration, best shown in FIG. 8, allows liquid 300 to drain out of planter 100 in various ways. Liquid 300 can drain out of planter 100 through drainage aperture 20 proximate bottom end 16 of container 11 by flowing through inner floor apertures 30a. Further, liquid 300 can drain out of planter 100 by flowing through outer floor apertures 30b, into drainage channel 25, over plurality of arcuate trapezoidal protrusions 26, and out plurality of apertures 18 on sidewall 10. Even further, liquid 300 can drain through a gap (defined by the difference between thickness T_{RF} of removable floor 30 and width W_{G} of groove 17 as shown in FIG. 12) between removable floor 30 resting on lip 24 and the top surface of plurality of apertures 18 of sidewall 10.

FIG. 12 illustrates removable floor 30 resting on surface 24² of lip 24¹, which lip transitions and slopes downwardly into the internal floor flange, and snappingly engaged within groove 17 of container 11. Thickness T_{RF} of removable floor 30 is slightly less than width W_{G} of groove 17, which allows removable floor 30 to snappingly engage groove 17 to hold removable floor 30 in place within container 11. FIG. 12 also illustrates protruding structure 18¹ which at least partially surrounds each aperture of plurality of apertures 18 of sidewall 10. To frictionally and/or snappingly insert removable floor 30 within groove 17, floor 30 much be frictionally pressed past each of protruding structure 18¹ which extend radially inward from sidewall 10. To facilitate this action, edge 30¹ of floor 30 has a rounded or filleted surface to smoothly pass over the tapered upper surface 18² of structure 18¹. To increase the retention of floor 30 within container 11, even if disengaged with groove 17, floor 30 must also pass over one or more the tapered lower surface 18³ of structure 18¹ or the internal surface of aperture 18. Tapered lower surface 18³ of structure 18¹ is the surface that houses each aperture of plurality of apertures 18 of sidewall 10.

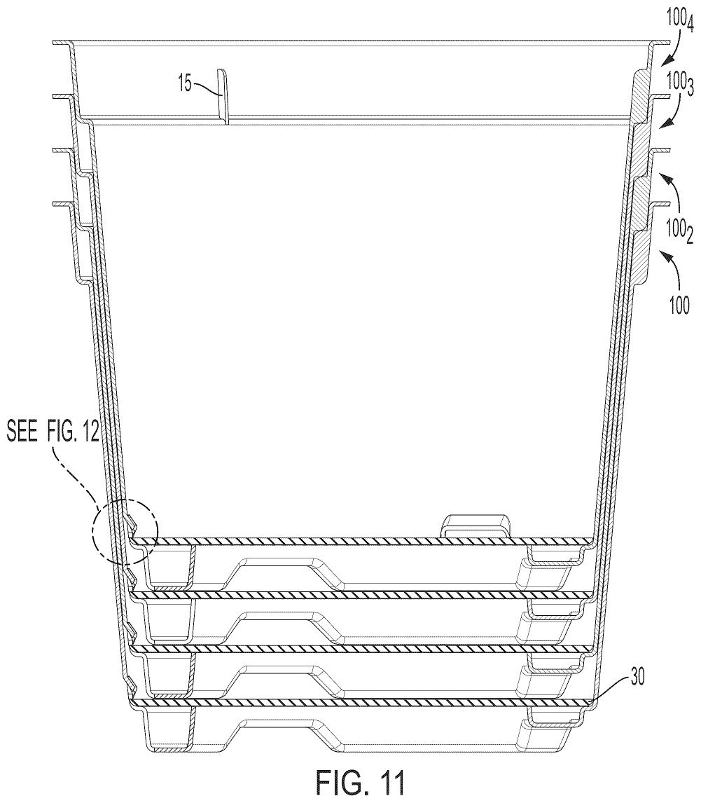

FIG. 11 illustrates multiple planters 100, 100₂, 100₃, 100₄, stacked on top of one another as removable floor 30 snappingly engages container 11. Plurality of vertical protrusions 15 of inner surface of sidewall 10a allow stable stacking of planters 100, 100₂, 100₃, 100₄. Removable floor 30 remains in place even when planters 100, 100₂, 100₃, 100₄ are split apart or inverted.

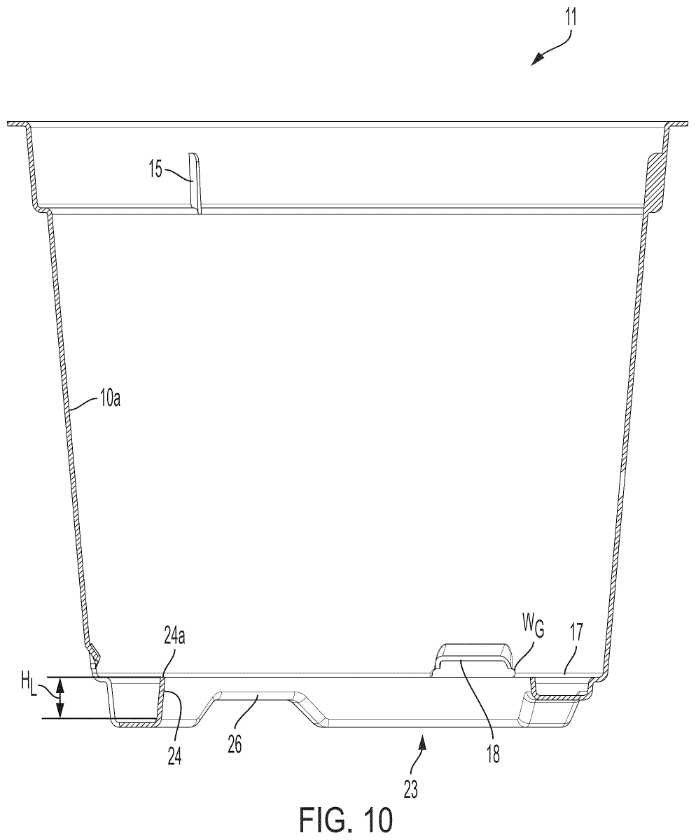

As best shown in FIGS. 10 and 12, the lower portion of container 11 is specifically configured to securely hold removable floor 30 while allowing for easy, push-through removal. Internal floor flange 23 extends inwardly from inner surface 10a of sidewall 10 proximate bottom end 16. Extending upwardly from internal floor flange 23 is lip 24 and lip 24¹, which forms upward-facing support surfaces 24a and 24², respectively. The combination of sidewall 10, flange 23, and lips 24, 24¹ defines peripheral drainage channel 25 that is in fluid communication with plurality of apertures 18 in the sidewall. At a position vertically above support surface 24² of the lip 24¹, a groove 17 is formed in the inner surface of sidewall 10. Removable floor 30 is arranged to be inserted into container 11 where it comes to rest on the support surface 24² of lip 24¹, which provides stable vertical support. Concurrently, the periphery of removable floor 30 snappingly engages groove 17, which provides lateral retention to securely lock the floor in place during use. This unique “rest-on, snap-above” configuration decouples the vertical support function (provided by the lip) from the lateral retention function (provided by the groove), creating a stable assembly that can be easily disassembled by applying an upward force to the bottom of removable floor 30, through aperture 20, to disengage it from groove 17.

As best shown in FIG. 12, container 11 is configured with a multi-stage retention system to securely hold removable floor 30. Extending radially inward from the inner surface of sidewall 10 is a plurality of protruding structures 18¹, each of which at least partially surrounds aperture 18. Located vertically below these protruding structures 18¹, primary retention groove 17 is formed in the inner surface of sidewall 10. The system is designed for the insertion of removable floor 30, which is configured to first be frictionally pressed past the plurality of protruding structures 18¹. This insertion is facilitated by a tapered upper surface 18² on each protruding structure, which guides a corresponding rounded peripheral edge 30¹ of the removable floor smoothly past this secondary retention point. Once the removable floor 30 is past the protruding structures 18¹, it is then able to snappingly engage the primary retention groove 17, locking it securely in its final position. This unique multi-stage configuration provides distinct tactile feedback during insertion and creates a highly secure assembly, with the protruding structures 18¹ providing secondary retention against unintentional upward movement, supplementing the primary retention offered by groove 17.

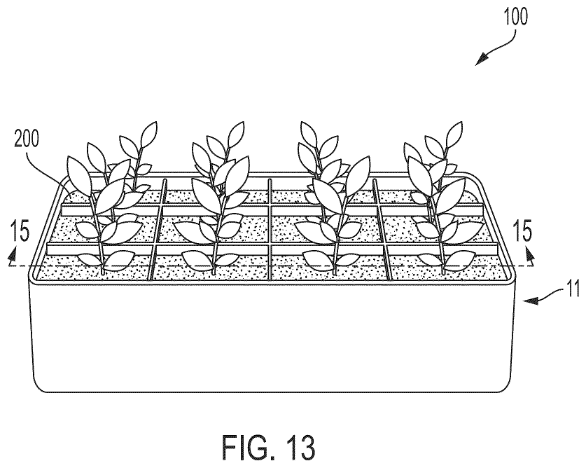

Adverting now to FIGS. 13-15 which illustrate the second preferred embodiment of the present invention. As shown in FIG. 13, planter 100 comprises container 11 with multiple sections to plant and grow multiple seedling plants 200.

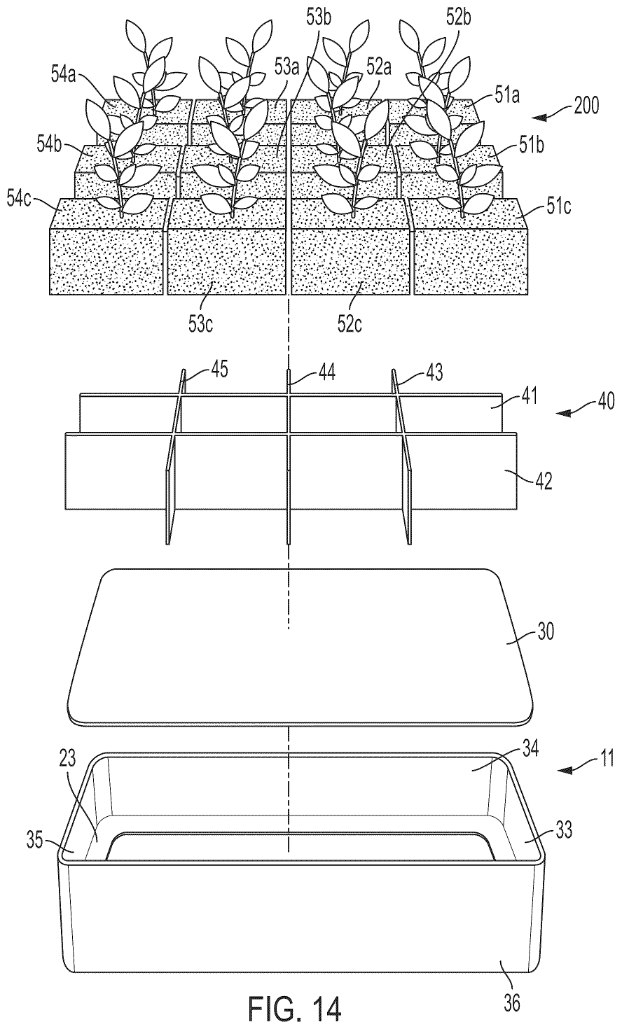

FIG. 14 illustrates container 11 that comprises internal floor flange 23, first wall 33, second wall 34, third wall 35, and forth wall 36. In a preferred embodiment plurality of walls 33, 34, 35, and 36 are integral, although obviously the walls could be discrete and secured to one another. Plurality of removable partitions 40 comprises first row wall 41, second row wall 42, first column wall 43, second column wall 44, and third column wall 45. Plurality of row walls 41 and 42 are slidably secured to plurality of column walls 43, 44, 45, at intersection points. In an alternative embodiment, plurality of removable partitions 40 may have more than two row walls or more than three column walls to accommodate a greater number of seedling plants 200.

Removable floor 30 is operatively arranged to rest on bottom internal floor flange 23 of container 11. A fully assembled planter 100 has removable floor 30 resting within container 11 on flange 23, with plurality of removable partitions 40 resting thereon. When assembled, planter 100 can accommodate a plurality of seedling plants in soil 200. Plurality of removable partitions 40 creates twelve compartments to create plurality of seedling plants in soil 200, operatively arranged to rest on the top surface of removable floor 30. Plurality of removable partitions 40, first row wall 41, second row wall 42, first column wall 43 in combination with container 11 first wall 33, second wall 34, and fourth wall 36, create three (3) four-sided compartments operatively arranged to hold first section of seedling with soil 51a, second section of seedling with soil 51b, and third section of seedling with soil 51c. Plurality of removable partitions 40 first row wall 41, second row wall 42, first column wall 43, second column wall 44 in combination with container 11 second wall 34 and fourth wall 36, create three (3) four-sided compartments operatively arranged to hold fourth section of seedling with soil 52a, fifth section of seedling with soil 52b, and sixth section of seedling with soil 52c. Plurality of removable partitions 40 first row wall 41, second row wall 42, second column wall 44, third column wall 45 in combination with container 11 second wall 34 and fourth wall 36, create three (3) four-sided compartments operatively arranged to hold seventh section of seedling with soil 53a, eighth section of seedling with soil 53b, and ninth section of seedling with soil 53c. Plurality of removable partitions 40 first row wall 41, second row wall 42, third column wall 45 in combination with container 11 second wall 34, third wall 35, and fourth wall 36, create three (3) four-sided compartments operatively arranged to hold tenth section of seedling with soil 54a, eleventh section of seedling with soil 54b, and twelfth section of seedling with soil 54c.

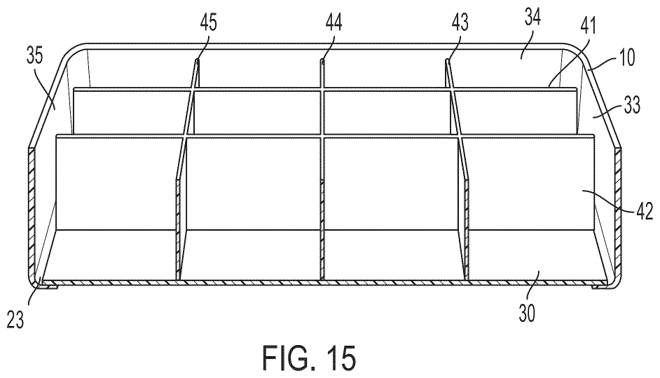

FIG. 15 illustrates a sectional view of container 11, removable floor 30, and plurality of removable partitions 40. Removable floor 30 sits within container 11 and on internal floor flange 23, allowing liquid 300 to drain through the bottom of container 11. Removable partitions 41, 42, 43, 44, and 45 rests on the top surface of floor 30.

To remove any one of plurality of seedling plants in soil 200, removable floor 30 of planter 100 may be placed on a raised surface like an inverted plant pot. Container 11 may then be slid in the downward direction, leaving removable floor 30, plurality of removable partitions 40, and plurality of seedling plants in soil 200. Outer seedlings, 51a, 51b, 51c, 52a, 52c, 53a, 53c, 54a, 54b, and 54c, may be lifted or slid out either by hand or with a small hand tool for transplanting. Inner seedlings 52b and 53b may be removed for transplanting by removing one or more of plurality of removable partitions 40, e.g., first row wall 41 of plurality of removable partitions 40 and first column wall 43 of plurality of removable partitions 40. Planter 100 may be assembled and disassembled many times to accommodate different individual seedling growth and timing for transplanting.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the figures attached hereto.

### REFERENCE NUMERALS

10 sidewall of planter 100
10a inner surface of sidewall 10
10b outer surface of sidewall 10
11 container of planter 100
12 top end of container 11
14 outside edge of top end 12 of container 11
13 top opening of top end 12
15 plurality of vertical protrusions of inner surface 10a of sidewall 10
16 bottom end of container 11
17 groove of sidewall 10
17a surface of groove 17
18 plurality of apertures of sidewall 10
18¹ protruding structure
18² upper surface
18³ lower surface
20 drainage aperture
23 internal floor flange
24 lip (inner)
24¹ lip (outer)
24² surface of lip 24¹
25 drainage channel
26 plurality of arcuate trapezoidal protrusions of drainage channel 25
26a top surface of arcuate trapezoidal protrusions 26
30 removable floor
30¹ edge of removable floor 30
30a plurality of inner floor apertures
30b plurality of outer floor apertures
30c center of removable floor 30
33 first wall of container 11
34 second wall of container 11
35 third wall of container 11
36 fourth wall of container 11
40 plurality of removable partitions
41 first row wall of plurality of removable partitions 40
42 second row wall of plurality of removable partitions 40
43 first column wall of plurality of removable partitions 40
44 second column wall of plurality of removable partitions 40
45 third column wall of plurality of removable partitions 40
51a first section of seedling in soil
51b second section of seedling in soil
51c third section of seedling in soil
52a fourth section of seedling in soil
52b fifth section of seedling in soil
52c sixth section of seedling in soil
53a seventh section of seedling in soil
53b eight section of seedling in soil
53c ninth section of seedling in soil
54a tenth section of seedling in soil
54b eleventh section of seedling in soil
54c twelfth section of seedling in soil
100 planter
100₂ stacked planter 2
100₃ stacked planter 3
100₄ stacked planter 4
200 plant and soil/seedlings and soil
300 liquid
D_{I} diameter of inner floor apertures 30a
D_{O} diameter of outer floor apertures 30b
H_{L} height of lip 24
H_{T} height of arcuate trapezoidal protrusion 26
T_{RF} thickness of removable floor 30
W_{G} width of groove 17

What is claimed is:

1. A planter, comprising:
a continuous sidewall with an inner surface and an outer surface forming a container, the container having a top end and a bottom end;
an internal floor flange extending inwardly from the inner surface of the sidewall proximate the bottom end;
a lip extending upwardly from the internal floor flange, wherein the lip defines an upward-facing support surface;
a drainage channel formed by the internal floor flange, the lip, and the sidewall;
a plurality of apertures in the sidewall in communication with the drainage channel;
a groove formed in the inner surface of the sidewall, wherein the groove is located vertically above the support surface; and,
a removable floor arranged to rest on the support surface to be vertically supported thereby, and to snappingly engage the groove to be laterally retained thereby.

2. The planter of claim 1, wherein the removable floor comprises a plurality of inner floor apertures and a plurality of outer floor apertures.

3. The planter of claim 2, wherein the plurality of inner floor apertures are arranged to drain liquid through a drainage aperture defined by the lip, and the plurality of outer floor apertures are arranged to drain liquid via the drainage channel and the plurality of apertures in the sidewall.

4. The planter of claim 1, wherein the drainage channel further comprises a plurality of arcuate trapezoidal protrusions.

5. The planter of claim 4, wherein a top surface of each of the plurality of arcuate trapezoidal protrusions is located vertically below a top edge of the lip.

6. The planter of claim 1, wherein the continuous sidewall is frustoconical in shape.

7. The planter of claim 1, wherein the removable floor is configured to disengage from the groove and slide upwardly toward said top end in response to an upward force applied to a bottom surface of the removable floor.

8. The planter of claim 1, wherein the removable floor comprises a plurality of inner floor apertures and a plurality of outer floor apertures.

9. The planter of claim 1, wherein the removable floor comprises a plurality of inner floor apertures and a plurality of outer floor apertures.

10. The planter of claim 9, wherein the plurality of inner floor apertures are arranged to drain liquid through a drainage aperture defined by the lip, and the plurality of outer floor apertures are arranged to drain liquid via said drainage channel and the plurality of apertures in the sidewall.

11. The planter of claim 1, further comprising a plurality of vertical protrusions formed on the inner surface of the sidewall, the vertical protrusions being located proximate the top end of the container and being configured to aid nesting with another like planter.

12. A planter, comprising:
a continuous sidewall with an inner surface forming a container, the container having a top end and a bottom end;
a plurality of protruding structures extending radially inward from the inner surface of the sidewall, each of the protruding structures at least partially surrounding an aperture formed in the sidewall;
a groove formed in the inner surface of the sidewall, the groove located vertically below the plurality of protruding structures; and,
a removable floor arranged within the container; wherein sa the id removable floor is configured to be frictionally pressed past the plurality of protruding structures during insertion to snappingly engage the groove.

13. The planter of claim 12, wherein each of the plurality of protruding structures comprises a tapered upper surface configured to guide the removable floor toward the inner surface of the sidewall during insertion.

14. The planter of claim 13, wherein the removable floor comprises a rounded peripheral edge adapted to smoothly pass over the tapered upper surface of each of the plurality of protruding structures during insertion.

15. The planter of claim 12, wherein each of the plurality of protruding structures further comprises a tapered lower surface configured to provide secondary retention against upward movement of the removable floor.

16. The planter of claim 12 further comprising:
an internal floor flange extending inwardly from the inner surface of the sidewall; and,
a lip extending upwardly from the internal floor flange, the lip being located vertically below the groove and configured to provide vertical support for the removable floor when the removable floor is engaged with the groove.

17. The planter of claim 12, wherein the groove has a width and the removable floor has a thickness, and wherein the thickness of the removable floor is less than the width of the groove to allow the removable floor to snappingly engage the groove.
